(19) United States
(12) Patent Application Publication
(10) Pub. No.: US 2003/0110618 A1
(43) Pub. Date: Jun. 19, 2003

(54) Multi-task steel process device

(76) Inventor: James M. Magnuson, Kankakee, IL (US)

Correspondence Address: SONNENSCHEIN NATH & ROSENTHAL, P.O. BOX 061080, WACKER DRIVE STATION, CHICAGO, IL, 60606-1080, US

(21) Appl. No.: 10/017,556

(22) Filed: Dec. 14, 2001

(51) Int. Cl. B23Q 15/00; B23P 21/00

(52) U.S. Cl. 29/720

(57) ABSTRACT

A multi-task process for simultaneously and independently processing a workpiece. A primary transfer and measuring system and an auxiliary transfer and measuring system transfer a workpiece through a first process and a second process wherein the first process and the second process simultaneously and independently perform operations on the workpiece.

### BACKGROUND OF THE INVENTION

The present invention relates to devices for processing structural steel workpieces. In particular, the invention relates to systems to independently perform multiple processes on the workpieces.

In working with structural steel workpieces, it is frequently necessary to cut the workpiece to length, to cut out a portion of the workpiece and/or to drill the workpiece with bores which may accommodate bolts or rivets for attachment to one or more connecting plates or for the attachment of one piece to another. Thus, in the erection of a structure or assembly of the pieces into structural units, bolts typically secure the ends of the workpieces and/or portions of the workpieces.

Structural workpieces are intended to encompass pieces such as, but not limited to, I-beams, H-beams, angles, channels, bar stock and even tubular stock, which may be used in construction. Thus, the present invention relates to steel profiles or members of various cross sectional shapes which are generally elongated and are referred commonly in construction as beams or girders.

Structural steel fabricators typically receive the structural workpieces from mills and fabricate the finished workpieces by cutting the workpieces to the finished lengths and drilling holes in the workpieces for receiving bolts as necessary to erect the workpieces in a structure. Processed workpieces typically have a central web and two parallel flanges—one flange at each end of the web.

Many products manufactured today by the fabricators typically involve one or more processing cells effected on the workpieces. For example, with metal workpieces, such multiple processing can involve cutting, punching, drilling, and the like on the workpiece.

Rapidly processing steel workpieces through different processing cells is crucial to maintaining an efficient and economical workflow of the workpiece. As such, performing two processes on a workpiece at the same time is important. Current systems place a saw and drill side by side or in series to reduce the amount of floor space required for installing process cells. Typical systems use a measuring or positioning wagon connected to the workpiece, which must travel the entire length of each process step, in order to pass the piece through each step.

In these systems, fabricators usually load a workpiece into the saw cell where an operator manually cuts the leading end of the workpiece. Then, the cut workpiece is conveyed to the drill cell. Drilling proceeds until the dimension from the leading end of the workpiece to the saw is exactly the same as the required cut length at which the piece is again sawed. After the piece is again sawed, the drill bores the balance of the required holes in the trail end of the workpiece. There is a potential that the drill and saw could function simultaneously in this orientation, but only if the fixed offset between the drill and saw exactly match the spacing between the drilling and sawing requirements of the piece. For example, if the orientation is such that the saw and the drill are eight feet apart, it would then be possible to drill holes that are eight from the end of the workpiece at the same time the workpiece is cut to length.

A problem with processing workpieces with these configurations, however, is that rarely, if ever, two different processes are configured to accommodate such exact spacing. Accordingly, the problem with processing workpieces is being able to perform two different processes at separate locations on the workpiece, such as the saw or drill, at the same time.

A need therefore exists to independently and simultaneously operate two different processes such as the drill and saw on the workpiece. The solution, however, must eliminate the ability to saw and drill simultaneously only when the offset between the drill and saw is exactly the same as the drilling and sawing length requirement. Further, a need exists which permits one workpiece to be positioned and sawed at the same time the next workpiece is positioned and drilled while avoiding collision of the pieces. Further a need exists to process workpieces by eliminating a measuring and positioning wagon. The solution, however, must also eliminate hoses, wires, cables and encoding or measuring instruments that must travel the entire length of each processing cycle which provide a maintenance problem. A need also exists to eliminate the time required to clamp and unclamp the workpiece during each process step such as the drilling and sawing cycle. The solution however, must engage the workpiece during the positioning, drilling and sawing cycle to properly align, if the workpiece is bent or otherwise out of tolerance, and perform the required process on the workpiece. Additionally, this solution must engage the workpiece to prevent the workpiece from jumping prior to each processing cycle.

### SUMMARY OF THE INVENTION

The present invention provides a multitable system in which more than one cell can be performed simultaneously on a workpiece and subsequent workpieces even if the spacing along the workpiece where the multiple cells are to be performed is not the same as the spacing between cells for performing the operations.

To that end, the invention provides that such a system transfers and measures a workpiece in which a primary transfer and measurement system is associated with an upstream operation and an auxiliary transfer and measurement system is associated with a downstream operation.

The present invention relates to a multi-task process device, in particular, a steel processing device that simultaneously and independently processes a workpiece and subsequent workpieces. Described in the accompanying drawings and following text is a multi-task process device that can perform a first process and a second process on the same workpiece. This configuration leads to cost reductions and improved efficiency. Thus, the invention disclosed herein provides a multi-task process device which overcomes many of the inadequacies of steel processing operations known in the art. The invention provides for a primary transfer and measuring system and an auxiliary transfer and measuring system to transfer and measure the workpiece through the first process and the second process.

In an embodiment, the multi-task process device comprises a first process and a second process wherein the second process is positioned downstream of the first process. Further, a primary transfer and measuring system is associated with the first process and an auxiliary transfer and measuring system positioned downstream of the second process is associated with the second process. The primary transfer and measuring system and the auxiliary transfer and measuring system are in communication with a controller. The controller responds to the primary transfer and measuring system and the auxiliary transfer and measuring system to simultaneously but independently activate the first process and the second process on the workpiece.

In an embodiment, the first process comprises a hole processor such as a drill system comprising a horizontal drill assembly and a vertical drill assembly. In this embodiment, the horizontal drill assembly includes a plurality of drills positioned on opposite sides of the workpiece while the vertical drill assembly includes a plurality of drills positioned above the workpiece.

In an embodiment, the second process comprises a sectioning machine such as a saw system. In this embodiment, the saw system includes a saw blade positioned within a saw bed.

In an embodiment, in order to displace the workpiece through the first process, the primary transfer and measuring system comprises a plurality of primary measuring discs which measure the lineal displacement of the workpiece through the first process. The primary measuring discs, which are freewheeled discs, rotate as the workpiece moves through the first process. In response to the movement, the primary measuring disc transmits a signal to the controller. The controller, in turn, signals primary drive rolls to continue transferring the workpiece through the first process. Further, in response to the primary measuring disc, the controller signals clamps to engage the workpiece at a programmed location within the first process.

In an embodiment, the invention provides the auxiliary transfer and measuring system to include at least one auxiliary measuring disc. The auxiliary measuring disc measures the lineal displacement of the workpiece out of the second process. The auxiliary measuring disc, which is a freewheeled disc, rotates as the workpiece moves through the second process. In response to the movement, the auxiliary measuring disc transmits a signal to the controller. The controller, in turn, signals a pair auxiliary drive rolls to transfer the workpiece through the second process.

The present invention also provides a method of processing the workpiece. In the method of operation, a first process is performed on a first end of the workpiece. The first end of the workpiece is then transferred into the second process via the primary transfer and measuring system. While the first end is positioned within the second process, the controller signals the first process to process a second end of the workpiece. Upon completion of processing the second end, the controller signals the auxiliary transfer and measuring system to transfer the second into the second process. The controller then signals the second process to process the second end. Simultaneously, the controller signals the primary transfer and measuring system to transfer a subsequent workpiece into the first process wherein the first process begins processing the first end of the subsequent workpiece while the second process is processing the second end of the prior workpiece. Upon completion of the first process and the second process, the workpiece is transferred out of the second process via the auxiliary transfer and measuring system and the subsequent workpiece is transferred into the second process.

In an embodiment, the method provides a plurality of primary drive rolls to contact the workpiece and transfer the workpiece through the first process. Additionally, the method provides that both sides of the workpiece are engaged by clamps to position the workpiece in the first process. The method further provides a pair auxiliary drive rolls to contact the workpiece and transfer the workpiece through the second process.

In an embodiment, the method provides a plurality of primary measuring discs to measure and signal the displacement of the workpiece through the first process. The method further provides at least one auxiliary measuring disc to measure and signal the displacement of the workpiece through the second process.

Another advantage of the present invention is to perform two processes at the same time on the workpiece.

An advantage of the present invention is to provide independent and simultaneous processes such as drilling and sawing on a workpiece.

Another advantage of the present invention is to accept a new workpiece when the last processed cycle is being performed on a previous workpiece.

Another advantage of the present invention is to eliminate a measuring wagon to further eliminate time lost in unclamping and clamping workpieces.

Another advantage of the present invention is to engage the workpiece during the positioning, first process and second process cells.

Another advantage of the present invention is to provide a primary transfer and measuring system and an auxiliary transfer and measuring system.

Another advantage of the present invention is to provide one universal CNC program for multiple processes which can direct different patterns on different workpieces.

### BRIEF DESCRIPTION OF THE DRAWINGS

FIG. 1 is a perspective view of a multi-task system embodying the principles of the present invention.

FIG. 2 is a perspective view of a hole processing system embodying the principles of the present invention.

FIG. 3 is a sectional view of FIG. 2

FIG. 4 is a perspective view of a primary transfer and measurement system.

FIG. 5 is a front view of a controller.

FIG. 6 is a sectional view of FIG. 4.

FIG. 7 is a perspective view of a sectioning machine embodying the principles of the present invention.

FIG. 8 is a front view of an auxiliary transfer and measuring system. 7.

FIG. 9 is a side view of FIG.

FIG. 10 is a plan view of a system utilizing a method of embodying the principles of the present invention.

FIG. 11 is a flow chart depicting an exemplary process for processing a workpiece.

### DETAILED DESCRIPTION OF THE PREFERRED EMBODIMENTS

The present invention is presently useful as a system for processing structural steel workpieces. In particular, the invention provides for independent and simultaneous operation of multiple processes on such workpieces.

In the embodiment described next, a universal CNC program is used in the control of a system for processing a workpiece through a variety of processing cells such as a saw, drill line, punch line and/or torch system. As fabricators expand their utilization of computerized detailing or CAD packages, the interface requirement of dealing with just one system can simplify the process and reduce fabrication costs. Accordingly, the present invention provides such a system which increases efficiency, capacity and output leading to economic gains.

For ease of description, the apparatus of this invention is described in a normal (upright) operating position, and terms such as upper, lower, horizontal, etc., are used relative to this position. It will be understood, however, that the apparatus of this invention may be manufactured, stored, transported, used, and sold in an orientation other than the position described.

The apparatus of this invention includes certain conventional components, including some actuators and control systems and mechanisms, the details of which, although not fully illustrated or described, will be apparent to those having skill in the art and an understanding of the necessary function of such components. Additionally, the present invention accommodates a full range of structural workpieces such as, but not limited to, beams, angles, channels, plates and tubes. Generally, the workpiece width ranges from three inches to fifty inches while the workpiece length is typically sixty feet.

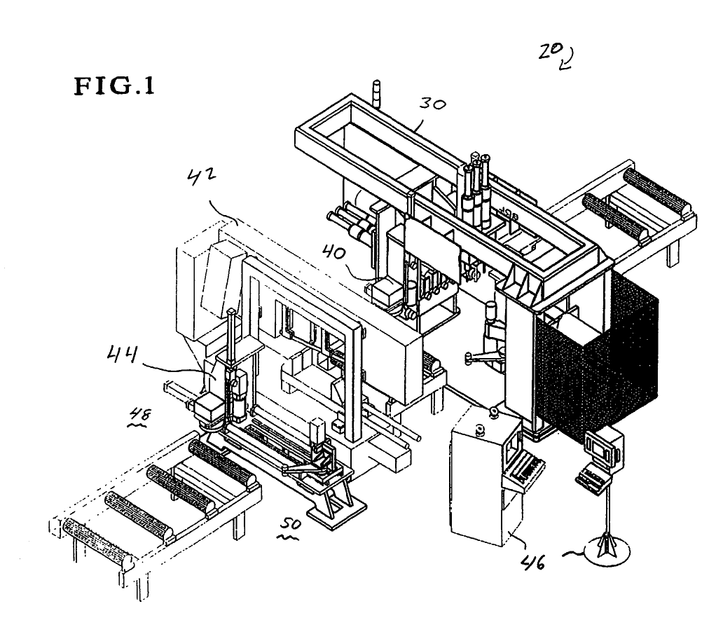

FIG. 1 illustrates a perspective view of an exemplary multi-task process device 20 for performing multiple processing operations on a workpiece 22, shown for illustration purposes as a structural steel I-beam. As shown in FIG. 1, the multi-task device 20 includes a process or first process 30, a primary transfer and measuring system 40, an additional process or second process 42, an auxiliary transfer and measuring system 44 and a controller or control system 46. The multi-task process device 20 has a datum side 48 and a non-datum side 50. In FIG. 1, the datum side 48 is shown on the left hand side and the non-datum side 50 is shown on the right hand side. It should be known that the present invention is not limited to two processes and two transfer and measuring systems. Accordingly, additional processes (not shown) and additional transfer and measuring systems (not shown) may be incorporated by the present invention. For illustration purposes, the first process 30, primary transfer and measurement system 40, the second process 42 and the auxiliary transfer and measurement system 44 are shown.

First Process

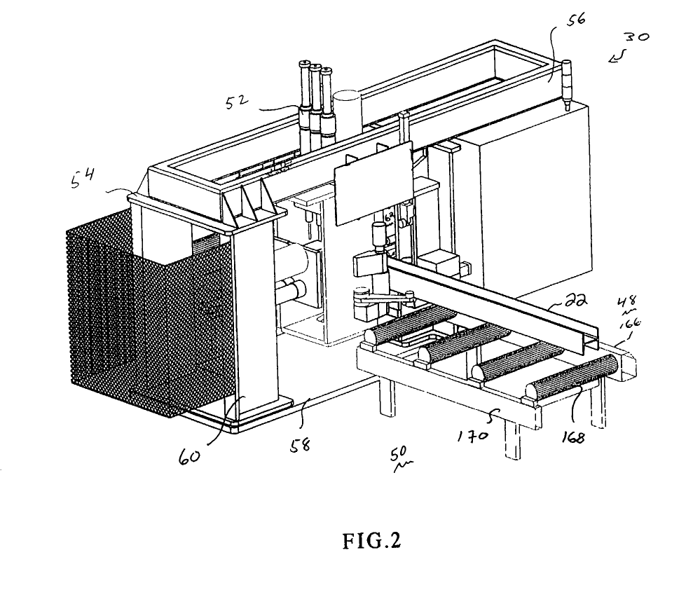

Referring to FIG. 2, the first process 30 is illustrated as a hole processing system 52, commonly a CNC system. It should be known that the hole processing system 52 may be any type of system, such as, but not limited to, a drill, a punch, a laser, a torch or any other type known in the art. The first process 30 comprises a frame 54 having an upper member 56, a base member 58, and side members 60. The frame 54 forms a bed 62 with an entry end and an exit end. Positioned underneath the upper member 56 is a movable track assembly which reciprocates back and forth from the non-datum side 50 toward the datum side 48. The track assembly positions components toward and away from the workpiece 22 as will be discussed below. A cable track also reciprocates with the track assembly to provide power to the track assembly. Accordingly, the track assembly laterally moves back and forth within the bed 62 to accommodate workpieces 22 having different widths.

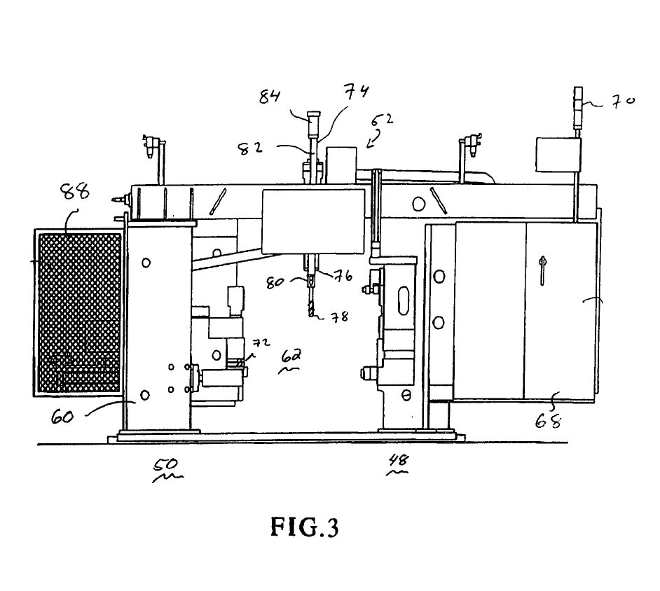

Turning to FIG. 3, the bed 62, the datum side 48 and the non-datum side 50 are shown along with other components such as a control panel 68 and safety signal 70. In the illustrated embodiment, the hole processing system 52 comprises a horizontal drill assembly 72 and a vertical drill assembly 74 positioned within the bed 62. Both the horizontal drill assembly 72 and the vertical drill assembly 74 comprise a plurality of drills 76 wherein each drill 76 includes a bit 78, a bore head 80, spindle 82 and hydraulic cylinder 84. The horizontal drill assembly 72 is positioned on both sides of the workpiece 22 (shown in FIG. 2) while the vertical drill assembly 74 is positioned above the workpiece 22.

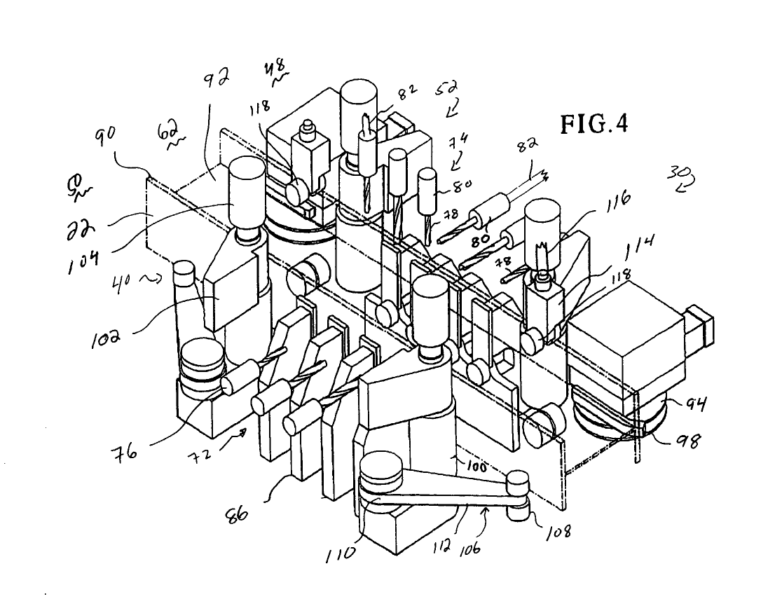

Turning to FIG. 4, three drills 76 of the horizontal drill assembly 72 are shown, positioned on the datum side 48 and the non-datum side 50, wherein the bore head 80 connects the bit 78 to the spindle 82. Clamps 86, positioned on the frame 54 (shown in FIG. 2), surround the drills 76. Although three drills 76 are shown on the datum side 48 and the non-datum side 50, other embodiments may incorporate one drill 76 or more than three drills 76 within the drill system 52.

A safety cage 88 (shown in FIG. 3) encloses the spindles 82 which extend beyond the side members 60 (shown in FIG. 3). The spindles 82 extend and retract the bits 78, via the hydraulic cylinders 84 (shown in FIG. 3), toward and away from the bed 62 to accommodate the different widths of the workpieces 22. The spindles 82 also extend and retract the bits 78 into and out of the workpiece 22 during the drilling cycle. Thus, the horizontal drill assembly 72 drills holes in the flanges 90 of the workpiece 22 in accordance with a programmed pattern of the controller 46 (shown in FIGS. 1 and 5). Accordingly, the vertical drill assembly 74 drills holes in the web 92 of the workpiece 22 in accordance with a programmed pattern of the controller 46.

Still referring to FIG. 4, in one embodiment, the drills 76 of the horizontal drill assembly 72 may be vertically positioned at different heights. With the varied heights, the drills 76 are capable of drilling holes into different heights along the flange 90 of the workpiece 22 according to the programmed pattern.

The vertical drill assembly 74 also comprises drills 76 wherein each drill 76 of the vertical drill assembly 74 includes the bit 78, the bore head 80, spindle 82 and hydraulic cylinder 84. In FIG. 4, three drills 76 are shown positioned extending vertically within the bed 62. Other embodiments, however, may incorporate one drill 76 or more than three drills 76. The spindles 82 extend beyond the upper member 56 (as shown in FIG. 3) to accommodate the different heights of the workpiece 22. The spindles 82 extend and retract, via hydraulic cylinders 84, the bits 78 into and out of the workpiece 22 in the vertical direction during the drilling cycle. Thus, the vertical drill assembly 74 drills holes through the web 92 of the workpiece 22 in accordance with the programmed pattern of the controller 46. As known in the art, the bits 78 of both the horizontal drill assembly 72 and the vertical drill assembly 74 are interchangeable to accommodate different sized holes.

Primary Transfer and Measuring System

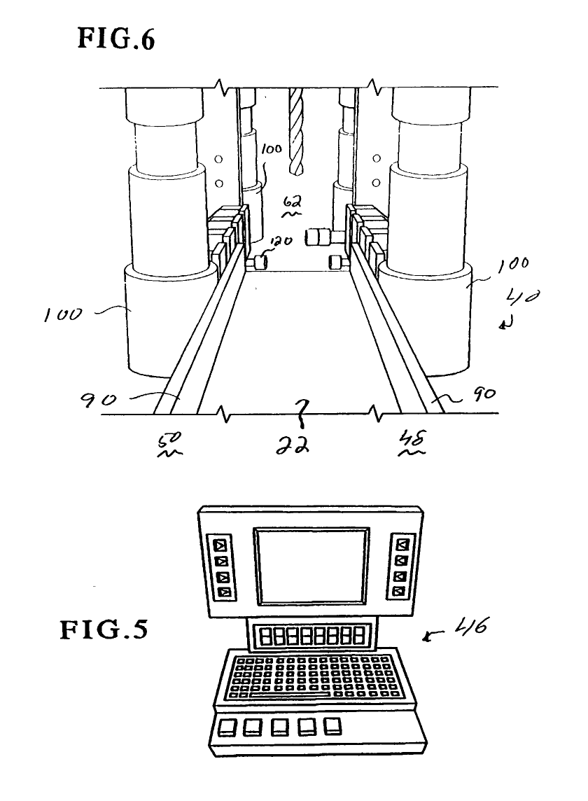

Turning to FIGS. 4 and 6, the primary transfer and measuring system 40 of the present invention is shown positioned within the first process 30. The primary transfer and measuring system 40 comprises a plurality of primary measuring discs 94, which are freewheeling, and a plurality of primary drive rolls 100 as shown in FIG. 4. In the illustrated embodiment, two primary measuring discs 94 are shown with one primary measuring disc 94 positioned near the entry end of the primary transfer and measurement system 40 and the second primary measuring disc 94 being positioned near the exit end of the primary transfer and measurement system 40. As shown in FIG. 4, the plurality of primary measuring discs 94 are positioned on the datum side 48.

Each primary measuring disc 94 also includes a primary guard 98 positioned above the primary measuring disc 94. The primary guard 98 deflects any workpiece 22 having a defect or burr for proper orientation to contact the primary measuring disc 94.

The primary measuring disc 94 communicates with the controller 46 and generates electrical impulses back to the controller 46 based on the movement of the workpiece 22. The accumulation of pulses from the primary measuring disc 94 determines the actual lineal location of the workpiece 22 as it is processed through the first process 30. Thus, the primary measuring disc 94 located near the entry end senses the workpiece 22 entering the first process 30 and provides inputs to the controller 46. In response by the controller 46, the clamps 86 located on the datum side 48 and the non-datum side 50 engage the workpiece 22 at the programmed location to position the workpiece 22 during operation of the first process 30. Upon completion of the first process 30, the primary measuring disc 94 located at the second end senses the workpiece 22 and provides an input to the controller 46. Also, the clamps 86, in response to a signal from the controller 46, disengage the workpiece 22 and the primary measuring disc 94 positioned at the second end measures the lineal location of the workpiece 22 as the workpiece 22 passes through and out the first transfer and measuring system 40 via the plurality of primary drive rolls 100.

In order to displace the workpiece 22, the primary transfer and measuring system 40 comprises the plurality of primary drive rolls 100 as shown in FIG. 6. The plurality of drive rolls 100 physically transfer the workpiece 22 through the first process 30. In the illustrated embodiment, two sets of primary drive rolls 100 are positioned on the datum side 48 and non-datum side 50 of the of the bed 62.

Returning to FIG. 4, on the datum side 48, the primary drive rolls 100 are positioned inside the primary measuring discs 94. The drive rolls 100 are connected to the frame 54 by primary roll mounts 102 and driven by primary roll motors 104. Thus, this unique arrangement incorporates a series of powered primary drive rolls 100 to pressure and position the workpiece 22 to the programmed location through the first process 30 without the need of a positioning or measuring type wagons attached to the workpiece 22. Since a measuring or positioning wagon is not required there are no hoses, wires, cables and encoding or measuring instruments incorporated into the present invention that must travel the entire length of each workpiece 22 processed eliminating common and costly maintenance problems.

The primary drive rolls 100 on the non-datum side 50 are positioned parallel across the bed 62 from the primary drive rolls 100 on the datum side 48. On both the datum side 48 and the non-datum side 50, the primary drive rolls 100 surround the horizontal drill assembly 72 as shown in FIG. 4. This novel 4×4 configuration can efficiently address the mill tolerance deviations and positioning accuracy of sections of the workpiece 22 up to 50″ (1250 mm) wide.

The primary drive rolls 100 communicate with the controller 46 wherein the controller 46, upon receipt of responses from the primary measuring discs 94, commands the primary drive rolls 100 to transfer the workpiece 22 through the first process 30. Accordingly, upon completion of the first process 30, the primary drive rolls 100 in response from the controller 46 transfer the workpiece 22 out of the first process 30.

In order to facilitate the engagement of the workpiece 22 through the first process 30, a plurality of primary breakaway devices 106 are positioned within the primary transfer and measuring system 40 as shown in FIG. 4. Typically, one primary breakaway 106 is positioned near the entry end while another primary breakaway device 106 is positioned near the exit end of the primary transfer and measuring system 40. Each primary breakaway 106 includes a primary roll end 108, a primary mount end 110 and a primary arm 112 positioned in between the primary roll end 108 and the primary mount end 110. The primary roll end 108 engages the workpiece 22 while the primary mount end 110 connects to the frame 54. The primary breakaway device 106 backs away from the datum side 48 to protect the primary measuring disc 94 if the workpiece 22 is clamped before the workpiece 22 is engaged by the first process 30. Thus, the primary breakaway devices 106 are positioned typically opposite the primary measuring discs 94.

The primary transfer and measuring system 40 also comprises a plurality of primary cam rolls 114 positioned on the datum side 48. In the illustrated embodiment, one primary cam roll 114 is positioned near the entry end generally between the primary measuring disc 94 and the primary drive roll 100. Accordingly, another primary cam roll 114 is positioned near the exit end after the primary measuring disc 94 of the primary transfer and measuring system 40. The primary cam rolls 114 comprise a retractable arm 116 and casters 118. The retractable arm 116, which is in communication with the controller 46, extends to engage the workpiece 22 being transferred through the first process 30. The casters 118 typically surround the flange 90 of the workpiece 22 to slide the workpiece 22 to the proper location and to further facilitate transferring the workpiece 22 through the first process 30.

Returning now to FIG. 6, the workpiece 22 is shown being engaged on both flanges 90 by the plurality of primary drive rolls 100 positioned at the first end of the primary transfer and measuring system 40. Roll guides 120 are positioned below the primary roll drives 100 to facilitate the measurement and transfer of the workpiece 22 as shown in FIG. 5. These roll guides 120 are positioned on both the datum side 48 and the non-datum side 50 of the bed 62.

Second Process

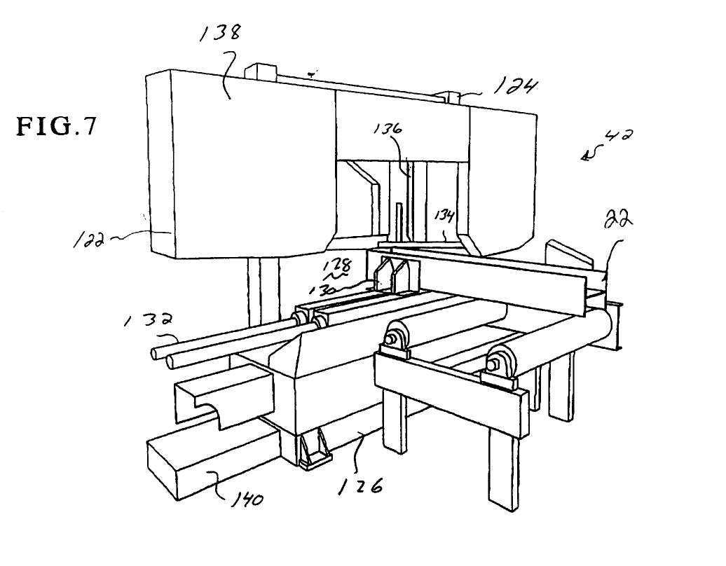

Turning to FIG. 7, the second process 42 is shown. In the illustrated embodiment, the second process cycle 42 comprises a sectioning machine 122 illustrated as a twin column band saw, typically a CNC system. It should be known that the sectioning machine 122 may be any type of sectioning machine 122, such as but not limited to, a saw, a laser, a torch or any other type of sectioning machine 122. In the illustrated embodiment, the sectioning machine 122 comprises a saw frame 124, saw base 126 and saw bed 128 as shown in FIG. 7. Positioned below the saw frame 124 are a plurality of guides 130 which are laterally adjustable to accommodate different widths of workpieces 22. Accordingly, the guides 130 automatically adjust by guide cylinders 132 to accommodate changing widths of the workpieces 22. The guide cylinders 132 eliminate having the operator to make manual blade guide adjustments since the guide cylinders 132 automatically adjust to the width of the entering workpiece 22 to be processed.

Positioned across the saw bed 128 is a blade 134 as shown in FIG. 7. To reduce resonance of the blade 134, an anti-resonance roller 136 may extend down from the saw frame 124. The anti-resonance roller 136 is extendable to follow the blade 134 in the cutting direction as the blade 134 cuts the workpiece 22. Typically, the sectioning machine 122 is configured to advance the blade 134 at a fixed six-degree angle for efficient cutting of the workpieces 22. The sectioning machine 122, however, may use other angles. Other embodiments may also use a saw base swiveling device (not shown) to pivot the blade 134 up to sixty degrees in each direction.

Another embodiment may also use a laser (not shown) positioned near the blade 134 to facilitate the accurate alignment of the blade 134 to a previously established layout mark. Still other embodiments may monitor the amperage drawn off of the blade motor 138 and change the speed of the blade 134 to compensate for the changing load applied on the blade 134.

The sectioning machine 122 further comprises a motorized chip conveyor 140 positioned below the blade 134 and the guide cylinders 132. The chip conveyor 140 efficiently removes the chips from the saw bed 128 reducing the maintenance of the sectioning machine 122 while improving the efficiency of the sectioning machine 122.

Auxiliary Transfer and Measurement System

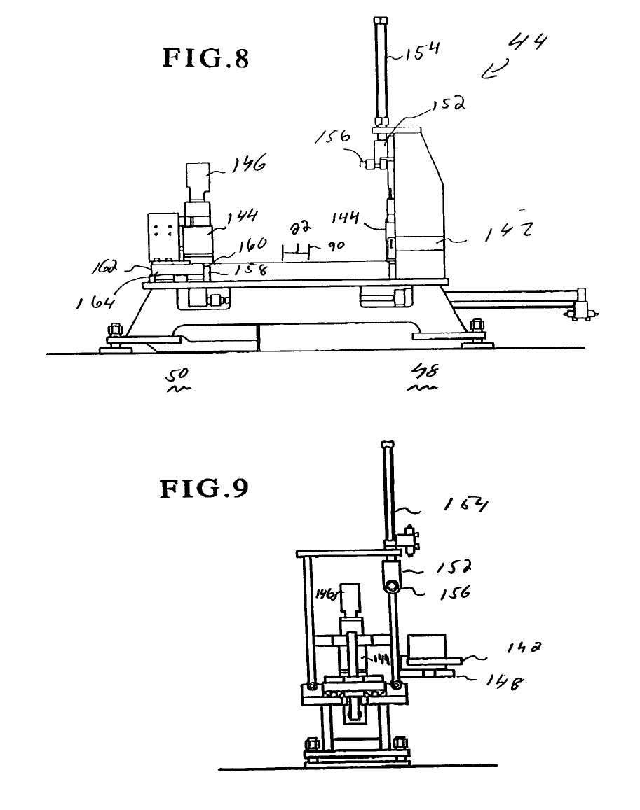

Turning to FIG. 8, an auxiliary transfer and measuring system 44 is shown configured similar to the primary transfer and measuring system 40. As shown in FIG. 8, the auxiliary transfer measuring system 44 comprises at least one auxiliary measuring disc 142, which is freewheeling, and a pair of auxiliary drive rolls 144. The auxiliary measuring disc 142 is positioned on the datum side 48 while one auxiliary drive roll 144 is positioned opposite the auxiliary measuring disc 142 on the non-datum side 50 and the other auxiliary drive roll 144 is positioned on the datum side 48.

Turning to FIG. 9, auxiliary measuring disc 142 includes an auxiliary guard 148 which deflects the workpiece 22, which may have a defect or a burr, for proper orientation to contact the auxiliary measuring disc 142.

The auxiliary measuring disc 142 also generates electrical pulses that are transmitted back to the controller 46 based on the movement of the workpiece 22. The accumulations of pulses from the auxiliary measuring disc 142 determines the actual lineal location of the workpiece 22 as it is processed through the second process 42. Thus, the auxiliary measuring disc 142 measures the lineal displacement of the workpiece 22 and transmits a signal, as a function of such displacement, to the controller 46.

Referring to FIGS. 8 and 9, the auxiliary drive roll 144 is shown. As shown, one auxiliary drive roll 144 is positioned on the non-datum side 50 of the auxiliary transfer and measuring system 44 opposite the auxiliary measuring disc 142. Accordingly, the other drive roll 144 is oppositely positioned on the datum side 48. In response to the signal from the auxiliary measuring disc 142, the program for the controller 46 directs the controller 46 to respond to the lineal displacement of the workpiece 22. The auxiliary drive rolls 144, driven by auxiliary roll motors 146, pressures and positions the workpiece 22 through the second process 42. Accordingly, the auxiliary drive rolls 144 are also in communication with the controller 46.

The auxiliary transfer and measuring system 44 also comprises at least one auxiliary cam roll 152 positioned on the datum side 48. In the illustrated embodiment, the auxiliary cam roll 152 is positioned near the exit end of the auxiliary transfer and measuring system 44. The auxiliary cam roll 152 comprises an auxiliary retractable arm 154 and an auxiliary caster 156.

The auxiliary retractable arm 154, which communicates with the controller 46, extends to engage the workpiece 22 as the workpiece is being transferred through and out of the second process 42. The auxiliary casters 156 typically surround the flange 90 of the workpiece 22 to further facilitate the transferring and measuring of the workpiece 22 through the second process 42.

The auxiliary transfer and measuring system 44 comprises an auxiliary breakaway device 158. Similar to the primary breakaway device 106, the auxiliary breakaway device 158 includes an auxiliary end 160, an auxiliary mount 162 and an auxiliary arm 164 positioned in between. This auxiliary breakaway device 158 backs away from the datum side 48 to protect the auxiliary measuring disc 142 if the workpiece 22 is clamped before the workpiece 22 is engaged by the second process 42.

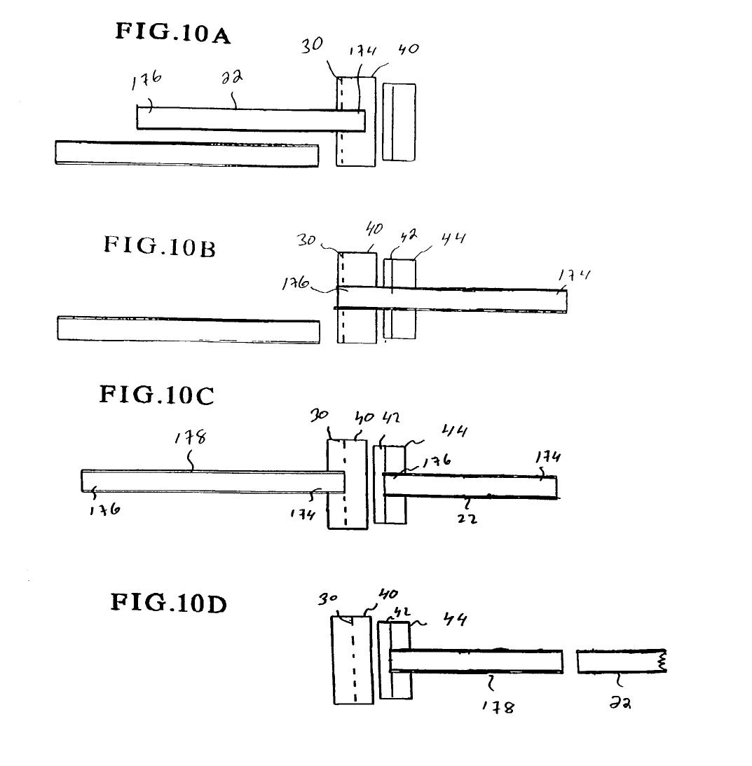

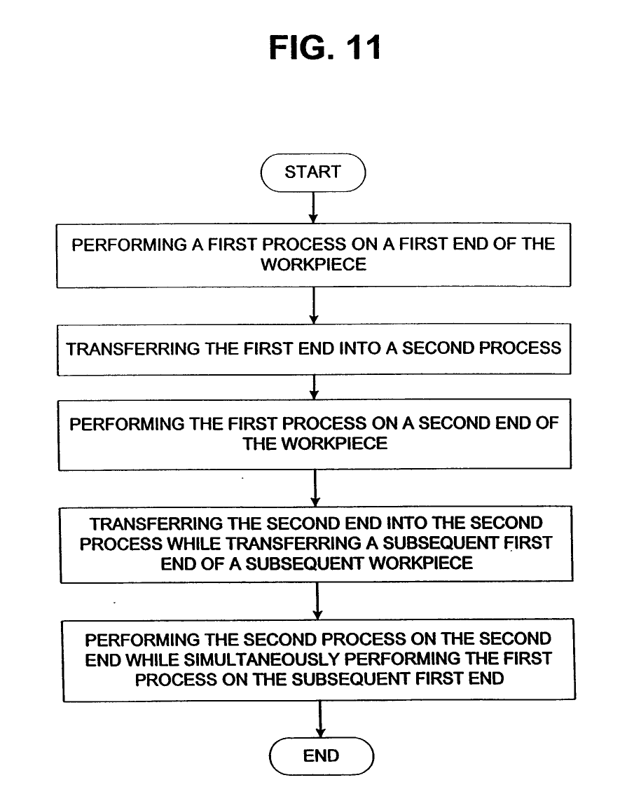

Turning to FIGS. 10A to 10D and 11 in combination with FIGS. 1-9, an exemplary method of operation of the present invention is shown using one universal CNC program. During operation, a conveyor system 166 (shown in FIG. 2) transfers the workpiece 22 from either a stock location or a previous process cell. The conveyor system 166 comprises cylinder rollers 168 supported by conveyor frames 170 (illustrated in FIG. 2) as commonly known in the art. As illustrated in FIGS. 10A-10D, the workpiece 22 has a first end 174 and a second end 176.

Referring to FIG. 10A, upon entering the primary transfer and measuring system 40, the controller 46 activates the preprogrammed pattern of processes to be applied to the workpiece 22. It should be known that the controller 46 is capable of storing and signaling different patterns to be applied to the workpiece 22. Accordingly, the controller 46 is capable of signaling different patterns from the first process 30 and the second process 42 onto the workpiece 22. The primary measuring disc 94, located near the entry end, measures the entering workpiece the 22 from the conveyor system 166 and generates impulses back to the controller 46 indicating the lineal location of the workpiece 22 as the workpiece 22 enters the first process 30.

In response, the controller 46 signals the primary drive rolls 100 to pressure the workpiece 22 and transfer the workpiece 22 from the conveyor system 166 to the programmed location within the first process 30 by the rolling motion of the primary roll drives 100. The controller 46 then signals the clamps 86 to engage both sides of the workpiece 22 to position the workpiece 22 at the programmed location. As previously shown in FIG. 4, the clamps 86 engage the workpiece 22 at the flanges 90. The controller 46 signals the primary drive rolls 100 to remain engaged during the positioning and processing of the workpiece 22 by the first process 30 thus eliminating positioning wagons and the time required to clamp and unclamp for each process. Furthermore, the primary drive rolls 100 remain engaged during the positioning and processing so the workpiece 22 will not move from the programmed location just prior to the operation of the first process 30 eliminating any jumping by the workpiece 22.

When the clamps 86 properly clamp the workpiece 22 at the programmed position, the controller 46 sends a signal to the first process 30. In the illustrated embodiment of FIG. 2, the first process 30 comprises a hole processing system 52 illustrated as the horizontal drill assembly 72 and the vertical drill assembly 74. In this embodiment, the drive cylinders 84 rotate the spindles 82 to bore the bits 78 of the horizontal drill assembly 72 into the flanges 90 near the first end 174 of the workpiece 22 according to the programmed pattern. The spindles 82 then retract the bits 78 out of the flanges 90. Accordingly, the vertical drill assembly 74 then bores the bits 78 into the web 92 near the first end 174 according to the programmed pattern. It should be known that the controller 46 may direct the vertical drill assembly 74 to operate before the horizontal drill assembly 72. In the alternative, the controller 46 is capable of directing either the horizontal drill assembly 72 or the vertical drill assembly 74 not to perform the drilling operation.

Depending on the particular program, the controller 46 may signal the horizontal drill assembly 72 and the vertical drill assembly 74 to drill a single hole or a plurality of holes into the workpiece 22. Accordingly, the drills 76 may be spaced horizontally and vertically to provide the required hole pattern comprising the plurality of holes.

Turning to FIG. 10B, upon completion of the first process 30 as applied to the first end 174, the clamps 86 disengage from the workpiece 22. The controller 46 then signals the plurality of drive rolls 100 to transfer the workpiece 22. The plurality of drive rolls 100 apply pressure to the workpiece 22 and begin rotating to transfer the first end 174 through the first process 30. The primary measuring disc 94 located near the exit end of the primary transfer and measuring system 40 generates electrical signals to the controller 46 to transmit the lineal displacement of the first end 174 of the workpiece 22 out of the first process 30. In this unique arrangement, the positive link between the workpiece 22 and the plurality of primary drive rolls 100 enables the workpiece 22 to be accelerated to the maximum speed virtually instantaneously. Further, the ability to accelerate and decelerate the workpiece 22 is not limited by the friction of the workpiece 22.

While the workpiece 22 is entering and exiting the first process 30, the controller 46 directs the primary cam rolls 114, located at the entry end and the exit end of the first process 30, to extend to meet the workpiece 22. The retractable arm 116 extends the casters 118 from the retracted positioned down to the flanges 90. The casters 118 then contact the flanges 90 to guide and align the workpiece 22 in and out of the first process 30. Additionally, the roll guides 120 positioned underneath the workpiece 22 and attached to the frame 54 assist in guiding the workpiece 22 through the first process 30.

As shown in FIG. 10B, the primary transfer and measuring system 40 transfers the first end 174 of the processed workpiece 22 into the second process 42. The primary drive rolls 100 transfer the workpiece 22 into the programmed location within the second process 42 while the primary measuring discs 94 continue measuring and signaling the lineal displacement of the workpiece 22 through to the controller 40 of the first process 30. The controller 46 then signals the auxiliary transfer and measuring system 44 to activate in order to continuing transferring the first end 174 into the second process 42. Accordingly, the auxiliary measuring disc 142 measures and signals the lineal displacement of the first end 174 into the second process 42 to the controller 46. In response, the controller 46 signals the pair of auxiliary drive rolls 144 to transfer the first end 174 to the programmed location into the second process 42.

When the first end 174 is positioned at the programmed location into the second process 42, the controller 46 signals the first process 30 to process the second end 176 of the workpiece 22 which is still positioned within the first process 30. In the illustrated embodiment, the horizontal drill assembly 72 and the vertical drill assembly 74 perform the drill process on the second end 150. Accordingly, the clamps 86 engage the workpiece 22 and the horizontal drill assembly 72 and the vertical drill assembly 74 drill the programmed holes into the flanges 90 and web 92 respectively in the second end 176. The controller 46 is capable of signaling the hole processing system 52 to process a single hole or a plurality of holes in the second end 178. Further, the controller 46 is capable of signaling a different drill pattern to the second end 176 than the first end 174.

Upon completion of applying the first process 30 to the second end 150, the controller disengages the clamps 86. The controller 46 then signals the primary measuring discs 94 and the primary drive rolls 100 to measure and transfer the second end 150 out of the first process 30. The controller signals the auxiliary transfer and measuring system 44 to continue transferring the second end 176 into the second process 42 to the programmed location. Accordingly, the auxiliary transfer and measuring system 44 via the auxiliary measuring discs 142 and the auxiliary drive rolls 144 transfers the second end 176 of the workpiece 22 to the programmed location within the second process 42.

Turning to FIG. 10C, the controller 46 then signals the second process 42 to begin processing the workpiece 22. In the illustrated embodiment, the second process 42 comprises a sectioning machine 122 illustrated as the saw system. The controller 46 signals the saw system 122 to position the saw blade 134 to engage the second end 176. The controller 46 signals the sectioning machine 122 to section part of the second end 176 off the workpiece 22. Thus, the controller 46 signals the sectioning machine 122 to section the workpiece 22 to the desired length. Accordingly, the controller 46 is capable of signaling the pair of auxiliary drive rolls 144 to position the workpiece 22 into the second process 42 of the programmed location to perform the sectioning to the desired length. The sectioned piece is discarded and transported by means known in the art. Thus, the workpiece 22 retains the hole patterns at the first end 174 and the second end 176 while being sectioned to the programmed length.

While the auxiliary transfer and measuring system 44 processes the cut workpiece 22, the controller 46 simultaneously signals the primary transfer and measuring system 40 to activate again. Since the multi-task device 20 system does not use a measuring carriage, when the last hole is drilled in the second end 176 and the second end 176 is transferred out of the first process 30, the first process 30 is free to accept a subsequent workpiece 178. There is no time lost to return back to the start location to clamp and process the subsequent workpiece 178.

The primary transfer and measuring system 40 then repeats the cycle by transferring and measuring the subsequent workpiece 178 into the first process 30. Thus, the controller 46 may “look ahead” and signal the first process 30 and the second process 42 to fabricate the subsequent workpiece 178 with the same or a different programmed hole pattern then the previous workpiece 22. Thus, while the second process 42 processes the second end 176 of the previous workpiece 22, the primary transfer and measuring system 40 loads the first end 174 of the subsequent workpiece 178 into the first process 30 and the first process 30 begins processing the first end 174 of the subsequent workpiece 178 via the controller 46. The auxiliary transfer and measuring system 44 permits the second end 176 of the prior workpiece 22 to be positioned and sectioned at the same time the first end 174 of the subsequent workpiece 178 is positioned and drilled. The first process 30 begins processing the first end 174 of the subsequent workpiece 178 while the second process 42 is processing the second end 176 of the prior workpiece 22. Thus, the controller 46 signals the first process 30 and the second process 42 to simultaneously and independently process the subsequent workpiece 178 and the prior workpiece 22.

Turning to FIG. 10D, when the second process 42 is completed, the controller 46 signals the auxiliary transfer and measuring system 44 to activate again. The auxiliary measuring disc 142 and the auxiliary drive roll 144 transfer the now cut workpiece 22 out of the second process 42 and transmit electrical pulses back to the controller 46 to signal the lineal displacement of the cut workpiece 22. Based on this determination by the auxiliary measuring disc 142, the controller 46 signals the auxiliary drive roll 144 to continue pressuring and continue transferring the now cut workpiece 22 out and away from the second process 42. Once the cut workpiece 22 is transferred out of the second process 42 and the first process 30 has completed the hole processing cycle on the subsequent workpiece 178, the primary transfer and measuring system 40 transfers the first end 174 of the subsequent workpiece 178 into the second process 42 to repeat operation again.

While the workpiece 22 is entering and exiting the second process 42, the controller 46 directs the auxiliary cam roll 152 to extend and meet the workpiece 22. The auxiliary retractable arm 136 extends the auxiliary caster 156 from the retracted positioned down to the flange 90. The auxiliary caster 156 then contacts the flanges 90 to guide and align the workpiece 22 in and out of the second process 42. Additionally, the roll guides 120 positioned underneath the workpiece 22 on the auxiliary transfer and measuring system 112 assist in guiding the workpiece 22 through the second process 42.

In an alternative method, the second process 42 may process the first end 174 of the workpiece 22 when the first end 174 enters the second process 42. In this method, the controller 46 signals the second process 42 to process the workpiece 22 to the programmed length and then signals the auxiliary transfer and measurement system 44 to transfer the workpiece 22 out of second process 42 upon completion.

It should be known to those skilled in the art that the length of the primary transfer measuring system 30 and the auxiliary transfer and measuring system 44 is not limited to the configuration illustrated and may be increased with the additional primary measuring discs 94, auxiliary measuring discs 142, primary drive rolls 100 and auxiliary drive rolls 144. Further, additional transfer and measuring systems and additional processes may also be added to the present invention.

It will also be understood that different energy sources can be used, such as pneumatics or hydraulics, without departing from the spirit and scope of the present invention. Further, while a horizontally-oriented multi-task process device has been described, it will be understood that alternate configurations could be utilized in connection with the present invention.

From the foregoing, it will be observed that numerous modifications and variations can be effected without departing from the true spirit and scope of the novel concept of the present invention. It is to be understood that no limitation with respect to the specific apparatus illustrated herein is intended or should be inferred. It is, of course, intended to cover by the appended claims all such modifications as fall within the scope of the claims.

I claim:

1. A multi-task processing device, comprising:
a process subject to controller;
a primary transfer and measuring system associated with the process to transfer and measure a workpiece and subsequent workpieces through the process;
at least one additional process subject to controller downstream of the process to further process the workpiece and subsequent workpieces; and
an auxiliary transfer and measuring system associated with at least one additional process to transfer and measure the workpiece and subsequent workpieces through the at least one additional process, wherein the primary transfer and measuring system and the auxiliary transfer and measuring system are in communication with the controller to independently activate the process and at least one additional process on the workpiece and subsequent workpieces.

2. The multi-task steel processing device of claim 1, wherein the process comprises a hole processing system.

3. The multi-task processing device of claim 2, wherein the hole processing system comprises a drill system.

4. The multi-task processing device of claim 3, wherein the drill system comprises a horizontal drill assembly and a vertical drill assembly.

5. The multi-task processing device of claim 4, wherein the horizontal drill assembly comprises at least one drill positioned on opposite sides of each workpiece.

6. The multi-task processing device of claim 4, wherein the vertical drill assembly comprises at least one drill positioned above each workpiece.

7. The multi-task processing device of claim 1, wherein the primary transfer and measuring system comprises a plurality of primary measuring discs, the primary measuring discs being positioned to track the lineal location of each workpiece.

8. The multi-task processing device of claim 1, wherein the primary transfer and measuring system comprises a plurality of drive rolls, the drive rolls being positioned to pressure and transfer each workpiece through the process.

9. The multi-task processing device of claim 1, wherein the primary transfer and measuring system comprises a plurality of clamps positioned on opposite sides of each workpiece.

10. The processing device of claim 1, wherein the at least one additional process is a sectioning machine.

11. The multi-task processing device of claim 10, wherein the sectioning machine comprises a saw assembly.

12. The multi-task processing device of claim 1, wherein the sectioning machine auxiliary transfer and measuring system comprises at least one auxiliary measuring disc, the at least one auxiliary measuring disc being positioned to track the lineal location of each workpiece.

13. The multi-task processing device of claim 1, wherein the auxiliary transfer and measuring system comprises at least one auxiliary drive roll, at least one auxiliary drive roll being positioned to pressure and transfer each workpiece through and out of the at least one additional process.

14. A multi-task processing device to perform multiple processes simultaneously and independently on a workpiece and subsequent workpieces, comprising:
a first process, the first process comprising a drill system positioned to accept the workpiece and subsequent workpieces, the drill system having a plurality of drills positioned around the workpiece;
a primary transfer and measuring system associated with the first process, the primary transfer and measuring system positioned to transfer and measure the workpiece and subsequent workpieces to a programmed position between the plurality of drills;
a second process, the second process comprising a saw assembly positioned downstream of the first process; and
a controller, the controller in communication with the first process, the primary transfer and measuring system and the second process wherein the controller signals the first process and the second process to simultaneously process the workpiece and subsequent workpieces.

15. The multi-task processing device of claim 14, further comprising an auxiliary transfer and measuring system associated downstream of the second process, the auxiliary transfer and measuring system being in communication with the controller.

16. The multi-task processing device of claim 14, wherein the primary transfer and measuring system comprises a plurality of primary measuring discs, the primary measuring discs being positioned to track the lineal location of each workpiece through the first process.

17. The multi-task processing device of claim 14, wherein the primary transfer and measuring system comprises a plurality of drive rolls, the drive rolls being positioned to pressure and transfer each workpiece through the first process.

18. The multi-task steel processing device of claim 14, wherein the primary transfer and measuring system comprises a plurality of clamps positioned on opposite sides of each workpiece.

19. The multi-task steel processing device of claim 14, wherein the auxiliary transfer and measuring system comprises at least one auxiliary measuring disc, the auxiliary measuring disc being positioned to track the lineal location of each workpiece through the first process.

20. The multi-task steel processing device of claim 13, wherein the auxiliary transfer and measuring system comprises at least one auxiliary drive roll, the auxiliary drive roll positioned to pressure and transfer each workpiece out of the second process.

21. A multi-task structural steel processing device to perform multiple processes simultaneously and independently on a workpiece and subsequent workpieces, comprising:
a first process positioned to accept each workpiece, the first process being subject to a controller;
a primary transfer and measuring system associated with the first process, the primary transfer and measuring system comprising a plurality of primary measuring discs, the plurality of primary measuring discs being positioned to signal to the controller the lineal location of each workpiece in the first process;
a second process subject to the controller positioned downstream of the first process to receive each workpiece; and
an auxiliary transfer and measuring system positioned downstream of the second process, the auxiliary transfer and measuring system comprising at least one auxiliary measuring disc, the at least one auxiliary measuring disc being positioned to signal to the controller the lineal location of each workpiece through the second process.

22. The multi-task structural steel processing device of claim 21, wherein the first process comprises a drill system.

23. The multi-task steel processing device of claim 22, wherein the drill system comprises a horizontal drill assembly and a vertical drill assembly.

24. The multi-task steel processing device of claim 23, wherein the horizontal drill assembly comprises at least one drill positioned on opposite sides of each workpiece and the vertical drill assembly comprises at least one drill positioned above each workpiece.

25. The multi-task structural steel processing device of claim 21, wherein the primary transfer and measurement system further comprises a plurality of drive rolls.

26. The multi-task steel processing device of claim 20, wherein the second process comprises a saw system.

27. The multi-task steel processing device of claim 20, wherein the auxiliary transfer and measurement system further comprises a pair of auxiliary drive rolls.

28. A method of processing a workpiece, comprising:
a. performing a first process on a first end of the workpiece;
b. transferring the first end into a second process;
c. performing the first process on a second end of the workpiece;
d. transferring the second end into the second process while transferring a subsequent first end of a subsequent workpiece into the first process; and
e. performing the second process on the second end while simultaneously performing the first process on the subsequent first end.

29. The method of processing a workpiece according to claim 28, further comprising transferring the second end out of the second process.

30. The method of processing a workpiece according to claim 28, further comprising transferring the subsequent workpiece into the second process.

31. The method of processing a workpiece according to claim 28, further comprising measuring the lineal displacement of each workpiece through the first process and the second process.

32. The method of processing a workpiece according to claim 28, further comprising signaling the lineal displacement of each workpiece to a controller.

33. The method of processing a workpiece according to claim 28, further comprising applying a plurality of primary drive rolls to each workpiece.

34. The method of processing a workpiece according to claim 28, further comprising applying a pair of auxiliary drive rolls to each workpiece.

35. The method of processing a workpiece according to claim 28, wherein the first process comprises processing holes into each workpiece.

36. The method of processing a workpiece according to claim 28, wherein the second process comprises sectioning each workpiece.

37. The method of processing a workpiece according to claim 28, further comprising engaging each workpiece during the first process and the second process.

38. A method of processing multiple operations simultaneously and independently on a workpiece and subsequent workpieces, comprising:
a. transferring a first workpiece into a first process;
b. signaling the displacement of the workpiece into the first process;
c. performing a first process on a first end of the workpiece;
d. transferring the first end into a second process;
e. performing the first process on a second end of the workpiece;
f. transferring the second end into the second process while transferring a subsequent first end of a subsequent workpiece into the first process;
g. performing the second process on the second end while simultaneously performing the first process on the subsequent first end; and
h. transferring the second end out of the second process while transferring the subsequent first end into the second process.

39. The method according to claim 38, further comprising performing the first process on a subsequent second end of the subsequent workpiece.

40. The method according to claim 38, further comprising transferring the subsequent second end into the second process.

41. The method according to claim 38, further comprising performing the second process on the subsequent second end.

42. The method according to claim 38, further comprising signaling the lineal displacement of each workpiece through the first process by a plurality of primary measuring discs.

43. The method according to claim 38, further comprising transferring each workpiece through the first process by a plurality of primary drive rolls.

44. The method according to claim 38, further comprising signaling the lineal displacement of each workpiece through the second process by at least one auxiliary measuring discs.

45. The method according to claim 38, further comprising transferring each workpiece through the second process by a pair of auxiliary drive rolls.
